(19) United States
(12) Patent Application Publication
(10) Pub. No.: US 2018/0192652 A1
(43) Pub. Date: Jul. 12, 2018

(54) ANTIMICROBIAL AGRICULTURAL PRODUCTS, MANUFACTURING METHODS AND APPLICATION THEREOF

(71) Applicant: Frank Escobedo, Miami, FL (US)

(72) Inventor: Frank Escobedo, Miami, FL (US)

(21) Appl. No.: 15/403,565

(22) Filed: Jan. 11, 2017

(51) Int. Cl. A01N 59/16; A01N 25/08; A01N 25/34

(52) U.S. Cl. CPC A01N 59/16; A01N 25/34; A01N 25/08

(57) ABSTRACT

An antimicrobial agricultural product with antimicrobial properties to maintain a healthy plant includes an agricultural product made with at least one antimicrobial agent such a antimicrobial metal ion and/or associated polymers or nanoparticles compounded into a substrate such as plastic material. The agricultural product can prevent or impair the growth of microbial and pathogenic organisms on plants raised in or otherwise in contact with the agriculture products. Examples of the agriculture product include agricultural planters, watering systems, trays, and other agricultural components.

### FIELD OF THE INVENTION

The present invention relates to agricultural products, more particularly to agricultural products having antimicrobial properties to maintain plant health.

### BACKGROUND OF THE INVENTION

A problem associated with growing plants in conventional plant products, such as containers or beds, has been the accumulation and harboring of microbial and pathogenic organisms growth on the plants planted therein. The infestation of potted plants with algae, bacteria, fungus, mites and other pathogenic organisms has long been documented to have a negative impact on plant health. Current methods to eradicate the immediate growth of microbial and pathogenic organisms involve pesticides that can also be toxic to humans and the plants themselves. In addition prevention of microbial growth is still difficult as some of the aforementioned organisms can remain dormant in soil for gears, such as fungal spores.

### SUMMARY OF THE INVENTION

In view of the foregoing an object of the present invention is to provide an improved plant pot with antimicrobial properties to maintain plant health. According to one embodiment of the present invention, are antimicrobial agricultural product with antimicrobial properties to maintain a healthy plant includes an agricultural product made with at least one antimicrobial agent such as antimicrobial metal ion and/or associated polymers or nanoparticles compounded into a substrate such as plastic material. The agricultural product can prevent or impair the growth of microbial and pathogenic organisms, on plants raised in or otherwise in contact with the agriculture products. Examples of the agriculture product for growing, maintaining, feeding, and housing a plant include agricultural planters, watering systems, trays, and other agricultural components.

According to another embodiment of the present invention, a method for maintaining a plant against microbial and pathogenic microorganism growth comprises maintaining a plant or a portion thereof in an agricultural product made with at least one antimicrobial agent compounded into a substrate such as plastic material.

These and other objects, aspects and advantages of the present invention will be better appreciated in view of the drawings and following detailed description of preferred embodiments.

### DETAILED DESCRIPTION OF A PREFERRED EMBODIMENT

According to one embodiment of the present invention, an antimicrobial agricultural product which possesses antimicrobial properties to maintain a healthy plant includes agricultural product made with at least one antimicrobial agent such as an antimicrobial metal ion and/or associated polymers, nanoparticles, and, the like, compounded into a substrate such as plastic material. The agricultural product can prevent or impair the growth of microbial and pathogenic organisms on plants raised in or otherwise in contact with the agriculture products. Examples of the agriculture product used for the growth housing, feeding and maintenance of plants include agricultural planters, watering systems, trays, and other agricultural components, and combinations of such products.

As used herein, the term ‘antimicrobial agents’ refers to elements or compounds that have anti-microbial, anti-bacterial, anti-fungal, anti-algal or anti-viral properties. Examples of such agents include silver ions, silver nanoparticles, nanoparticles made of, gold (Au), platinum (Pt), silver (Ag), zinc (Zn), tellurium (Te) or copper (Cu), other metal ions, nanoparticles or compounds, combined forms of the foregoing plus chloride, bromide, iodide, and their complexes, and other forms.

The substrate is preferably porous and can be made of a polymer, or a non-polymer. Appropriate materials include but are not limited to cellulose esters, polyesters, vinyl polymers, cellulose acetate, cellulose acetate butyrate, polystyrene, polyvinyl chloride, polyethylene polypropylene, silicone, polyolefin, nylons, polyurethane, rubber, elastomers, clay, nylons, polycarbonates, poly(ether sulfones), ceramics, and mixtures thereof, Examples of suitable polyolefins include but are not limited to ethylene vinyl acetate; ethylene methyl acrylate; polyethylenes; polypropylenes; ethylene-propylene rubbers; ethylene-propylene-diene rubbers; poly(1-butene); polystyrene; poly(2-butene); poly(1-pentene); poly(2-pentene)' poly(3-methyl-1-pentene); poly(4-methyl-1-pentene); 1,2-poly-1,3-butadiene; 1,4-poly-1,3-butadiene; polyisoprene; polychloroprene poly(vinyl acetate); poly(vinylidene chloride), and mixtures and derivatives thereof.

The substrate impregnated with antimicrobial agent can further comprise other desirable materials, which include but are not limited to preservative, fragrance, colorants, fillers, emollients, and multiple inactive ingredients and mixtures thereof. Suitable fillers include but are not limited to carbon black, cellulose fiber powder, siliceous fillers, polyethylene fibers and filaments, and mixtures thereof.

According to another embodiment of the present invention, the agricultural product which possesses antimicrobial properties can be used to prevent and/or treat a plant or a portion thereof to eliminate or reduce one or more undesirable microorganisms. As used herein, ‘plant’ refers to any plant or vegetable, fruit, produce, plant seed, plant stem, plant root, and the like.

The antimicrobial agent such as silver compound or silver nanoparticles incorporated into the agricultural product (e.g., planter, pot, tray, etc.) are slowly released into the plant growth medium (e.g., soil) and then taken up by microbial and pathogenic microorganisms in the growth medium and the plant raised inside the agricultural product, leading to the death of the microorganisms but not posing a hazard to the plant itself. The anti-microbial agent can be maintained throughout the lifespan of plant raised therein. The slow and sustained release of antimicrobial agent into the growth medium and plant can thus prevent the growth of microorganisms, maintain their antimicrobial properties over time and support the cultivation of healthy plants.

According to one embodiment of the present invention, a method of making an agricultural product with antimicrobial properties includes the steps of incorporating, at least one antimicrobial agent into a substrate and molding the mixed material into a specific shape of the agricultural product.

In one aspect, incorporating n antimicrobial agent (e.g., silver nanoparticles) into a substrate (e.g., plastics material) includes mixing the antimicrobial agent and the substrate to produce a homogeneous composite material (e.g., a uniform collodial dispersion of the antimicrobial agent in the substrate). The antimicrobial agent will generally be particles 1-20 nanometers (nm) in diameter, and the concentration of the antimicrobial agent will preferably be 0.5-5% (w/v) for optimal antimicrobial activity. The composite material can then be fabricated by customary plastic processing methods into final shape suitable for an agricultural purpose.

An example method of incorporating an antimicrobial agent (e.g., silver ions) into substrate includes vaporing antimicrobial agent particles in a vacuum evaporator and coating the vaporized antimicrobial agent onto a powder precipitate of the substrate (e.g., cellulose acetate butyrate) spread out in a thin layer. The coated powder is then stirred up to expose a fresh surface and the coating process is repeated until certain amount of antimicrobial agent is mixed with the base material powder. The mixed powder is melted and injection molded into a specific shape of an agricultural product.

As another example, after a substrate (e.g., plastic) is molded to a shape of an agriculture product, a layer of antimicrobial agent (e.g., silver ion) is deposited on at least a portion of a surface (e.g., inner surface) of the molded agricultural product. In addition to antimicrobial properties the antimicrobial surface of the coating is anti-adhesive, making it easier to clean the agricultural product and preventing the bacterial and similar microorganism from growing on the surface of the agricultural product.

An example method of incorporating an antimicrobial agent (e.g., ionized silver nanoparticles) into a substrate (e.g., an organic polymer or a mixture of polymers) includes mixing the antimicrobial agent with zeolite particles and embedding the zeolite particle-antimicrobial agent mixture in the substrate. The resulting material can then be molded into an agricultural product. Zeolite is essentially aluminosilicate having a three-dimensional skeleton structure and a general chemical formula of xM_{2/n} O.Al₂O₃.ySiO₂ .zH₂O, wherein Al₂O₃ is the aluminosilicate base and M represents an ion-exchangeable metal ion, which is usually monovalent or divalent. As another example, zeolite particles are mixed with a substrate, the mixture is molded into a specific shape of an agricultural product, and the molded product is then treated with an aqueous solution of at least one water-soluble salt of at least one antimicrobial agent to provide zeolite particles embedded with the antimicrobial agent in the substrate. The process is described in the U.S. Pat. No. 4,911,898, the contents of which are hereby incorporated by reference in their entirety.

Other methods of incorporating an antimicrobial agent can be used. For example, nanoparticles or other additives can be incorporated into plastic material or other substrates using the methods described in U.S. Pat. No. 4,338,274, U.S. Pat. No. 6,894,085 and U.S. Pat. No. 2,947,646, the contents of which are hereby incorporated by reference in their entirety.

In general, the foregoing description is provided for exemplary and illustrative purposes, the present invention is not necessarily limited thereto. Rather, those skilled in the art will appreciate that additional modifications, as well as adaptations for particular circumstances, will fall within the scope of the invention as herein shown and described and the claims appended hereto.

1. An agricultural container having antimicrobial properties to grow and maintain a healthy plant comprising an agricultural container made with a substrate homogenously mixed with at least one antimicrobial agent.

2. The agricultural container of claim 1, wherein the at least one antimicrobial agent comprises silver ions.

3. The agricultural container of claim 1, wherein the at least one antimicrobial agent comprises silver nanoparticles.

4. The agricultural container of claim 1, wherein the at least one antimicrobial agent comprises antimicrobial metal ions.

5. The agricultural container of claim 1, wherein the at least one antimicrobial agent is embedded into a zeolite.

6. The agricultural container of claim 1, wherein the size of the antimicrobial agent is between 1 and 20 micron nanometers (nm) in diameter.

7. The agricultural product container of claim 1, wherein the concentration of the antimicrobial agent is between 0.5-5% w/v.

8. The agricultural container of claim 1, wherein the agricultural container comprises an agricultural planter.

9. The agricultural container of claim 1, wherein the substrate comprises at least one of cellulose esters, polyesters, vinyl polymers, cellulose acetate, cellulose acetate butyrate, polystyrene, polyvinyl chloride, polyethylene, polypropylene, silicone, polyolefin, polyurethane, rubber, elastomers, clay, and ceramic material.

10. (canceled)

11. (canceled)

12. A method for maintaining a plant against microbial and pathogenic microorganism growth comprising maintaining a plant or a portion thereof in an agricultural container made with a substrate homogenously mixed with at least one antimicrobial agent.

13. The method of claim 12, wherein the substrate comprises cellulose esters, polyesters, vinyl polymers, cellulose acetate, cellulose acetate butyrate, polystyrene, polyvinyl chloride, polyethylene, polypropylene, silicones, polyolefin, polyurethane, rubber, elastomers clay and ceramic material.

14. The method of claim 12, wherein the at least one antimicrobial agent comprises silver ions.

15. The method of claim 12, wherein the at least one antimicrobial agent comprises silver nanoparticles.

16. The method of claim 12, wherein the at least one antimicrobial agent comprises antimicrobial metal ions.

17. The method of claim 12, wherein the size of the antimicrobial agent is between 1 and 20 nm in diameter.

18. The method of claim 12, wherein the concentration of the antimicrobial agent is between 0.5-5% w/v.

19. The method of claim 12, wherein the agricultural comprises an agricultural planter, a watering system, a tray, and a combination thereof.

20. The method of claim 12, wherein plant growth medium is deposited in the agricultural container for maintaining the plant or a portion thereof raised inside the agricultural container.
